(19) United States
(12) Patent Application Publication
(10) Pub. No.: US 2021/0078542 A1
(43) Pub. Date: Mar. 18, 2021

(54) SNOW REMOVING DEVICE

(71) Applicant: DENSO CORPORATION, Kariya-city (JP)

(72) Inventors: Koji OTA, Kariya-city (JP); Kotaro FUKUDA, Kariya-city (JP); Yoshiyuki YOKOYAMA, Kariya-city (JP)

(21) Appl. No.: 17/102,199

(22) Filed: Nov. 23, 2020

Related U.S. Application Data
(63) Continuation of application No. PCT/JP2019/018572, filed on May 9, 2019.

(30) Foreign Application Priority Data
May 28, 2018 (JP) 2018-101309

(51) Int. Cl. B60S 1/48; H05B 3/14; H05B 3/84; H05B 1/02; F21S 45/60; B60S 1/60; B60Q 1/04

(52) U.S. Cl. CPC B60S 1/485; H05B 3/145; H05B 3/84; B60Q 1/04; F21S 45/60; B60S 1/603; H05B 1/0236

(57) ABSTRACT

A snow removing device includes a heater that is disposed in a moving body that has a light including a cover and a cleaner that ejects a washer solution toward an outer surface of the cover. The cover is exposed to an outside of the moving body, covers a light source, and allows light emitted from the light source to pass therethrough. The snow removing device further includes a control unit that controls the heater to heat the cover first, and then controls the cleaner to eject a washer solution toward the outer surface of the cover.

### CROSS REFERENCE TO RELATED APPLICATIONS

This application is a continuation application of International Patent Application No. PCT/JP2019/018572 filed on May 9, 2019, which designated the U.S. and claims the benefit of priority from Japanese Patent Application No. 2018-101309 filed on May 28, 2018. The entire disclosure of all of the above application is incorporated herein by reference.

### TECHNICAL FIELD

The present disclosure relates to a snow removing device.

### BACKGROUND ART

In a snow removing structure for a headlight, a front lens that covers a light source includes a heater. In such a structure, the front lens is heated by heat generated by the heater to melt snow adhering to the front lens.

### SUMMARY

One aspect of the present disclosure is a snow removing device applied to a moving body that has: a light including a cover that is exposed to an outside of the moving body, covers a light source, and allows light emitted from the light source to pass therethrough; and a cleaner that ejects a washer solution toward an outer surface of the cover. The snow removing device includes a heater that heats the cover and a control unit that controls the heater to heat the cover first, and then controls the cleaner to eject a washer solution toward an outer surface of the cover.

### BRIEF DESCRIPTION OF DRAWINGS

The above and other objects, features and advantages of the present disclosure will become more apparent from the following detailed description made with reference to the accompanying drawings.

FIG. 1 is a diagram showing the entire configuration of a headlight snow removing device according to a first embodiment.

FIG. 2 is a diagram showing a specific example of a heater of FIG. 2.

FIG. 3 is a diagram showing a specific example of the heater of FIG. 2.

FIG. 4 is a diagram showing an electrical configuration of the headlight snow removing device according to the first embodiment.

FIG. 5 is a flowchart showing a snow removing process by a control unit of FIG. 2.

FIG. 6 is a flowchart showing a snow removing process by the control unit in the headlight snow removing device according to a second embodiment.

### DESCRIPTION OF EMBODIMENTS

Hereinafter, embodiments of the present disclosure will be described with reference to the drawings. In the following embodiments, the same or equivalent parts are denoted by the same reference numerals as each other, and explanations will be provided to the same reference numerals for simplifying descriptions.

To begin with, a relevant technology will be described only for understanding the following embodiments. According to the study by the inventor, in a typical snow removing structure, even if the front lens is heated by the heat generated from the heater, if snow adheres thickly on the front lens, it is not possible to melt and remove the snow from the front lens. Or it will take a long time to remove the snow from the front lens.

It is an objective of the present disclosure to provide a snow removing device capable of quickly removing snow adhering to a light cover.

As described above, according to one aspect of the present disclosure, a snow removing device is applied to a moving body that has: a light including a cover that is exposed to an outside of the moving body, covers a light source, and allows light emitted from the light source to pass therethrough; and a cleaner that ejects a washer solution toward an outer surface of the cover. The snow removing device includes a heater that heats the cover and a control unit that controls the heater to heat the cover first, and then controls the cleaner to eject a washer solution toward an outer surface of the cover.

Accordingly, the snow adhering to the cover is heated by heating the cover with the heater, and then the washer solution is ejected from the cleaner to the snow adhering to the cover. Thus, it is possible to quickly remove the snow adhering to the cover of the light.

As described above, it is possible to provide a snow removing device capable of quickly removing the snow adhering to the cover of the light.

### First Embodiment

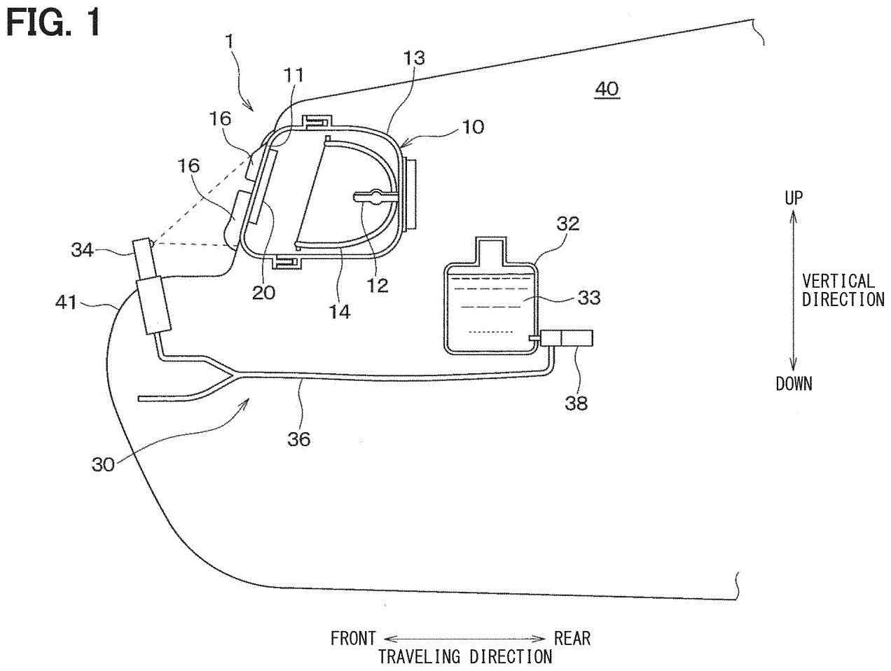

As shown in FIG. 1, a headlight snow removing device 1 of the present embodiment is applied to a headlight 10 of a vehicle to remove snow adhering to an outer surface of an outer lens 11 of the headlight 10. The headlight 10 is a headlight that is arranged to face the front side in a vehicle traveling direction of the vehicle and emits light toward the front side in the vehicle traveling direction.

Specifically, the headlight snow removing device 1 includes heaters 20 and a cleaner 30. The heaters 20 are formed to extend along an inner surface of the outer lens 11 of the headlight 10.

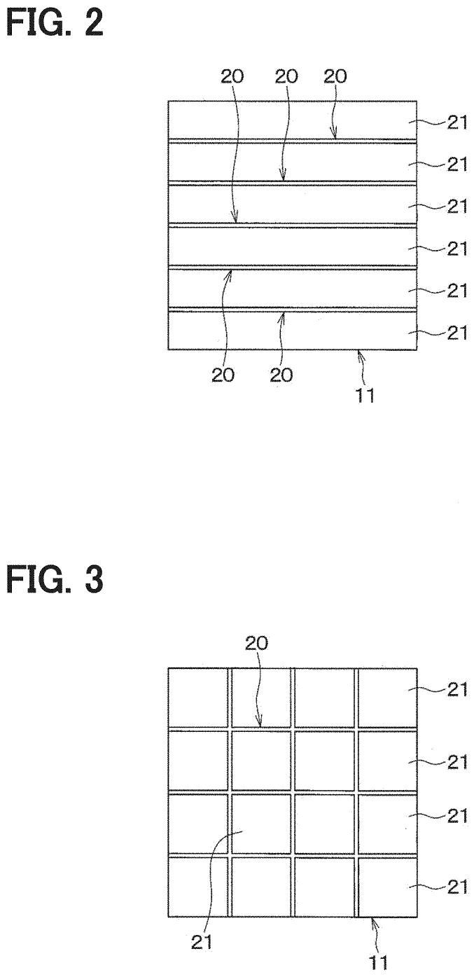

As shown in FIG. 2 or 3, the heaters 20 constitute a transparent heater formed in a film shape having a plurality of openings 21 and allowing the light emitted from the light source 12 to pass therethrough. The plurality of openings 21 serve to allow the light emitted from the light source 12 to pass therethrough.

In a specific example of FIG. 2, a plurality of wires are arranged as the heaters 20 so that the heaters 20 are spaced apart from each other. Each of the openings 21 is defined as a gap between adjacent ones of the plurality of heaters 20. For example, each of the heaters 20 may be formed of a wire member in a meandering shape and the opening 21 may be defined between the two wire members.

In another specific example of FIG. 3, the heaters 20 are arranged in a grid pattern to form a plurality of openings 21.

Each of the heaters 20 of the present embodiment is made of a carbon nanotube. CNT stands for a carbon nanotube. Here, the heaters 20 are attached to the inner surface of the outer lens 11. Alternatively, the heaters 20 and the outer lens 11 may be integrally molded as an integrally molded product when the outer lens 11 is injection-molded.

Here, the outer lens 11 of the headlight 10 is arranged to be exposed to an outside of the vehicle (specifically, the front side in the vehicle traveling direction). The outer lens 11 is made of a translucent resin material (or glass) and is formed to cover a light source 12 from the front side in the vehicle traveling direction. The outer lens 11 constitutes, together with a back cover 13, a storage for housing the light source 12 and a light reflecting portion 14.

The light reflecting portion 14 is formed in a cup shape with an opening directed toward the front side in the vehicle traveling direction, and reflects the light from the light source 12 toward the front side in the vehicle traveling direction. As the light source 12, a HID light source is used.

HID stands for a discharge headlight.

The cleaner 30 has a cleaner tank 32, a cleaner nozzle 34 disposed in front of the outer lens 11 in the vehicle traveling direction, and a hose 36 connecting the cleaner nozzle 34 and the cleaner tank 32.

The cleaner nozzle 34 is disposed in a front bumper 41 or the like in front of the headlight 10 in the vehicle traveling direction. The cleaner nozzle 34 is capable of ejecting a washer solution 33 from the cleaner tank 32 via the hose 36 onto the entire outer lens 11. The cleaner tank 32 is generally installed in an engine compartment 40, and the cleaner tank 32 is filled with the washer solution 33 for cleaning the outer lens 11 of a window shield and the headlight 10.

A cleaner controller 38 that is capable of controlling ejection of the washer solution 33 from the cleaner nozzle 34 is disposed in a lower side of the cleaner tank 32. One end of the hose 36 is connected to an end of the cleaner controller 38, and the other end is connected to the cleaner nozzle 34.

The cleaner controller 38 of the present embodiment is an electric pump that pumps the washer solution so that the washer solution in the cleaner tank 32 is ejected from the cleaner nozzle 34.

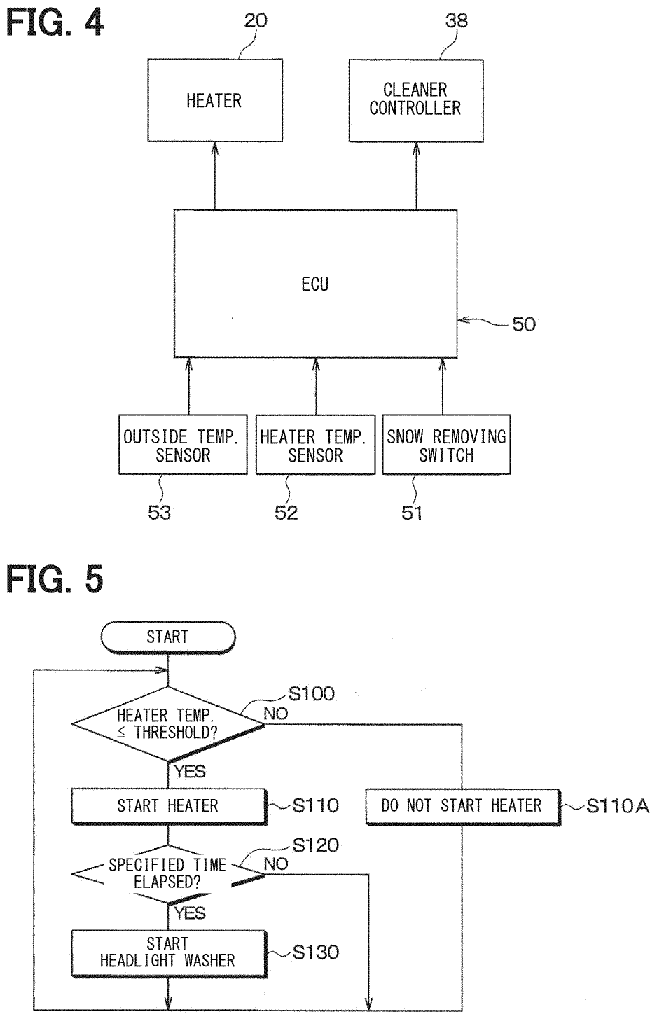

Next, an electrical configuration of the headlight snow removing device 1 of the present embodiment will be described with reference to FIG. 4.

The headlight snow removing device 1 includes an electronic control unit 50, a snow removing switch 51, a heater temperature sensor 52, and an outside temperature sensor 53.

The electronic control unit 50 includes a microprocessor, a memory, and the like, and executes a snow removing process in accordance with computer programs stored in advance in the memory. The electronic control unit 50 starts executing the snow removing process when the snow removing switch 51 is turned on by a user or when a command signal is received from another electronic control unit. The memory is a non-transitory tangible storage medium.

The snow removing switch 51 is a switch that receives a command signal to start removing snow and a command signal to stop removing snow according to an on/off operation by a user.

The electronic control unit 50 controls the heaters 20 and the cleaner controller 38 according to a detected temperature of the heater temperature sensor 52 during the snow removing process. The heater temperature sensor 52 is a heater temperature detector that detects a temperature of the heaters 20 as a temperature of the outer lens 11. The heater temperature sensor 52 of the present embodiment is disposed in the heaters 20. The outside temperature sensor 53 is an outside air temperature detector that detects a temperature of an air outside the vehicle.

Next, a specific operation of the headlight snow removing device 1 of the present embodiment will be described with reference to FIG. 5.

The electronic control unit 50 executes the snow removing process according to a flowchart of FIG. 5.

Initially, as a determination unit, the electronic control unit 50 detects a temperature of the heaters 20 by the heater temperature sensor 52 when the heaters 20 are off at step S100, and determines whether the detected temperature (hereinafter referred to as the detected heater temperature) is equal to or lower than a threshold.

As described above, the heaters 20 are formed to extend along the inner surface of the outer lens 11 of the headlight 10. Therefore, the detected temperature of the heater temperature sensor 52 indicates a temperature of the outer lens 11.

Then, when the detected heater temperature is higher than the threshold, the temperature of the outer lens 11 is determined to be higher than the threshold and “NO” is determined at step S100. Then at step S110A, the electronic control unit 50 maintains the heaters 20 to be off as a stop unit, and the process returns to step S100.

Accordingly, as long as the detected heater temperature (that is, the temperature of the outer lens 11) is higher than the threshold, the electronic control unit 50 maintains the heater 20 to be off and repeats “NO” determination at step S100.

Thereafter, when the detected heater temperature (that is, the temperature of the outer lens 11) decreases to be equal to or lower than the threshold (YES in step S100), the electronic control unit 50 operates the heaters 20 as a control unit (step S110).

Therefore, the temperature of the outer lens 11 is increased by heat generated by the heaters 20. As a result, the temperature of the snow 16 adhering to the outer surface of the outer lens 11 can be increased.

Next, at step S120, the electronic control unit 50 determines whether a specified time has elapsed since the heaters 20 started.

Then, if the elapsed time since the heaters 20 started (hereinafter, referred to as a heater operation time) is less than the specified time, “NO” is determined at step S120. Then, the process returns to step S100 while operation of the heaters 20 is maintained.

If the detected heater temperature is equal to or lower than the threshold and the heater operating time is less than the specified time, determination of YES at step S100, the process at step S110 (the heater operating process) and determination of NO at step S120 are repeated.

As a result, it is possible to continuously increase the temperature of the snow 16 adhering to the outer surface of the outer lens 11 by heat generated by the heaters 20.

Next, if the heater operating time exceeds the specified time, it is assumed that the heaters 20 have been continuously operated for the specified time, and YES is determined at step S120. As a result, the outer lens 11 can be heated by the heaters 20 to sufficiently apply heat to the snow 16 adhering to the outer surface of the outer lens 11.

After that, the electronic control unit 50 controls the cleaner controller 38 at step S130 as a control unit to apply pressure to the washer solution so that the washer solution in the cleaner tank 32 is ejected from the cleaner nozzle 34.

As a result, the washer solution 33 from the cleaner tank 32 via the hose 36 is ejected onto the entire outer lens 11. Therefore, the snow can be removed from the outer lens 11 for a short time.

After that, the heaters 20 are stopped and the cleaner controller 38 is stopped, and then the process returns to step S100. Therefore, in the same manner as described above, the control processes of steps S100, S110, S130, and step S110A are executed.

Therefore, after the heaters 20 continuously operate for the specified time, the washer solution is ejected from the cleaner nozzle 34 toward the snow 16 adhering to the outer lens 11. Accordingly, the snow can be removed from the outer lens 11 for a short time.

According to the present embodiment described above, the headlight snow removing device 1 is applied to a vehicle including the headlight 10 having the outer lens 11 and the cleaner 30 for ejecting a washer solution toward the outer surface of the outer lens 11. The outer lens 11 is formed of a translucent material to cover the light source 12, and allows light emitted from the light source 12 to pass therethrough.

The headlight snow removing device 1 includes the heater 20 that heats the outer lens 11. The electronic control unit 50 controls the heater 20 to heat the outer lens 11 by the heater 20, and then controls the cleaner controller 38 to eject the washer solution from the cleaner nozzle 34 toward the outer surface of the outer lens 11.

Therefore, the washer solution 33 is ejected onto the entire outer lens 11. Therefore, the snow can be removed from the outer lens 11 for a short time.

In the present embodiment, as described above, the outer lens 11 is heated by the heaters 20, and then the washer solution is ejected from the cleaner nozzle 34 toward the snow 16 adhering to the outer lens 11.

Therefore, the amount of washer solution required to remove the snow 16 from the outer lens 11 can be reduced as compared to when the washer solution is ejected from the cleaner nozzle 34 toward the outer lens 11 without heating the outer lens 11 first.

Further, in the present embodiment, power consumption consumed by the heaters 20 can be reduced as compared to when the snow 16 is removed from the outer lens 11 by simply heating the outer lens 11 with the heater 20 without using the washer solution.

In the present embodiment, the heaters 20 constitute the plurality of openings 21 and are arranged to extend along the inner surface of the outer lens 11. Therefore, the light emitted from the light source 12 can smoothly pass through the outer lens 21.

In particular, the heaters 20 are made of carbon nanotubes. Therefore, the heaters 20 can absorb the light emitted from the light source 12. Therefore, it is possible to prevent the light from the light source 12 from being scattered by the heaters 20, and thus the light emitted from the light source 12 can smoothly pass through the outer lens 11.

In the present embodiment, when the electronic control unit 50 determines that the temperature of the outer lens 11 is higher than the threshold, the heaters 20 stop heating the outer lens 11. As a result, when heating the outer lens 11 is unnecessary, it is possible to prevent the outer lens 11 from being heated by the heaters 20.

In particular, if a distance measuring sensor using light such as Lidar is arranged inside the headlight 10, snow can be quickly and smoothly removed from the outer lens 11 according to the present embodiment. Therefore, the period during which operation of the distance measuring device is disturbed by the snow 16 can be shortened.

### Second Embodiment

In the first embodiment, it is determined whether the temperature of the outer lens 11 is equal to or lower than the threshold based on the temperature of the heaters 20. However, in the second embodiment, it is determined whether the temperature of the outer lens 11 is equal to or lower than the threshold using an outside air temperature.

In the present embodiment, the outer lens 11 is exposed to an outside of the vehicle as described above. Therefore, it is assumed that the temperature of the outer lens 11 is substantially equal to the temperature of an air outside of the vehicle. Therefore, to detect a temperature of the outer lens 11, an outside air temperature sensor 53 is used as an outside air temperature detector instead of using the heater temperature sensor 52.

The present embodiment and the first embodiment have the same hardware configuration except the outside air temperature sensor 53 in the headlight snow removing device 1. Further, the flowchart used for executing the snow removing process in the electronic control unit 50 is different between the present embodiment and the first embodiment.

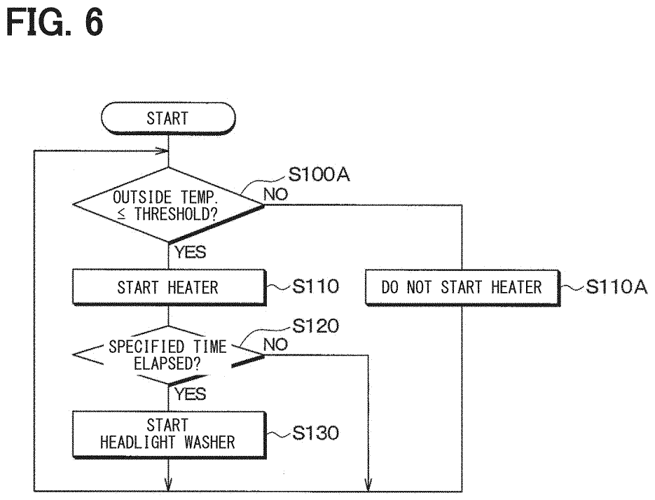

The snow removing process in the electronic control unit 50 will be described with reference to FIG. 6.

FIG. 6 is a flowchart showing a snow removing process executed by the electronic control unit 50.

The electronic control unit 50 executes the snow removing process according to a flowchart of FIG. 6 instead of FIG. 5.

FIG. 6 includes step S100A instead of step S100 in the flowchart of FIG. 5. Steps S110, S110A, S120, and S130 in FIG. 5 are the same as steps S110, S110A, S120, and S130 in FIG. 6. Hereinafter, in FIG. 6, the description of the same steps as in FIG. 5 will be omitted.

Initially, the electronic control unit 50 detects an outside air temperature by the outside air temperature sensor 53 when the heaters 20 off at step S100A, and determines whether the detected outside air temperature is equal to or lower than a threshold.

At this time, the detected temperature of the outside air temperature sensor 53 (that is, the outside air temperature) indicates a temperature of the outer lens 11. Then, when the outside air temperature is higher than the threshold, the temperature of the outer lens 11 is determined to be higher than the threshold and “NO” is determined at step S100A. Then at step S110A, the electronic control unit 50 maintains the heaters 20 to be off, and the process returns to step S100A.

Therefore, when the outside air temperature is higher than the threshold, NO determination at step S100A is repeated while the heater 20 is maintained to be stopped.

On the contrary, when the outside air temperature (that is, the temperature of the outer lens 11) decreases to be equal to or lower than the threshold, the electronic control unit 50 operates the heaters 20 in step 100A (step S110). Thereafter the control processes of steps S120 and S130 are executed in the same manner as in the first embodiment.

Therefore, after the heaters 20 are continuously operated for the specified time, the washer solution is ejected from the cleaner nozzle 34 toward the snow 16 adhering to the outer lens 11. Accordingly, the snow can be removed from the outer lens 11 for a short time.

According to the embodiment described above, the electronic control unit 50 controls the heaters 20 so that the outer lens 11 is heated by the heater 20. Then, the electronic control unit 50 controls the cleaner controller 38 to eject the washer solution from the cleaner nozzle 34 toward the outer surface of the outer lens 11. Therefore, as with the first embodiment, the washer solution 33 is ejected onto the entire outer lens 11. Therefore, the snow can be removed from the outer lens 11 for a short time.

In the present embodiment, the electronic control unit 50 determines whether the temperature of the outer lens 11 is equal to or lower than the threshold by determining whether the outside air temperature is equal to or lower than the threshold. When the electronic control unit 50 determines that the temperature of the outer lens 11 is higher than the threshold, the heaters 20 stop heating the outer lens 11. Therefore, as with the first embodiment, it is possible to prevent the outer lens 11 from being heated by the heaters 20.

### Other Embodiments

(1) In the first and second embodiments described above, the snow removing device is applied to a vehicle. However, instead, the device 1 may be applied to a moving body such as a train, an airplane, etc. other than a vehicle.

In this case, in the second embodiment, the electronic control unit 50 determines whether the temperature of the outer lens 11 is equal to or lower than the threshold based on the detected temperature of the outside air temperature sensor 53 that detects the temperature outside the moving body.

(2) In the first and second embodiments, the snow removing device is applied to the headlight 10, but instead, the snow removing device may be applied to a fog lamp or the like other than the headlight 10.

That is, the light to which the snow removing device is applied may be a light other than the headlight 10 as long as the outer lens 11 is exposed to the outside of the vehicle and snow can adhere to the light.

(3) In the first and second embodiments, the heaters 20 formed in a film shape by carbon nanotubes are used, but instead, the following (a) and (b) may be available.

(a) A heater 20 made of metal and applying heat to the outer lens 11 may be used. In this case, electric wires made of metal may be used as the heaters 20, or the heaters 20 formed of metal in a grid pattern may be used.

(b) A radiant heater that applies radiant heat to the outer lens 11 may be used as the heater 20.

(c) An air heating heater that heats the air in the space surrounded by the outer lens 11 and the back cover 13 to increase the temperature of the outer lens 11 may be used as the heater 20.

(4) In the second embodiment described above, the outside air temperature sensor 53 that detects a temperature of an air outside the vehicle is used, but instead, the following may be used.

That is, an on-board wireless terminal may be used as an outside air temperature detector that acquires the outside air temperature from a server outside the vehicle through the Internet or a wireless communication network. The electronic control unit 50 determines whether the temperature of the outer lens 11 is equal to or lower than the threshold based on the outside air temperature acquired by the on-board wireless terminal.

(5) In the first and second embodiments, the electronic control unit 50 may perform the following control after executing the control process in step S130.

Under this control, the electronic control unit 50 uses a camera to capture an image of the outer lens 11 of the headlight 10, and determines whether snow has been removed from the outer lens 11 based on captured image data.

When the electronic control unit 50 determines that the snow has not been removed from the outer lens 11, the determination process of step S100 (or S100A) is executed again. After that, each control process of steps S110, S120, and S130 is executed.

Thus, each control process of steps S100 (or S100A), S110, S120, and S130 is repeated until the snow is removed from the outer lens 11. Then, when the electronic control unit 50 determines that the snow is removed from the outer lens 11, the determination process of step S100 (or S100A) is stopped.

(6) The present disclosure is not limited to the above-described embodiments, and can be appropriately modified. The above embodiments are not independent of each other, and can be appropriately combined together except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Also, the shape, the positional relationship, and the like of the component or the like mentioned in the above embodiments are not limited to those being mentioned unless otherwise specified, limited to the specific shape, positional relationship, and the like in principle, or the like.

### Overview

According to a first aspect described in some or all of the first, second, and other embodiments, the snow removing device is applied to a moving body having: a light including a cover that is exposed to an outside of the moving body, covers a light source, and allows light emitted from the light source to pass therethrough; and a cleaner that ejects a washer solution toward an outer surface of the cover.

The snow removing device further includes a heater that heats the cover. The snow removing device includes a control unit that controls the heater so that the cover is heated by the heater, and then controls the cleaner so that the washer solution is ejected from the cleaner toward the outer surface of the cover.

According to a second aspect, the heater is configured to allow light from the light source to pass therethrough.

Therefore, it is possible to avoid a situation where the heater prevents the light from the light source from being emitted to an outside of the moving body.

According to a third aspect, the heater is formed of carbon nanotubes.

Therefore, since the heater absorbs the light from the light source, it is possible to prevent the light from the light source from being scattered by the heater.

According to a fourth aspect, a determination unit to determine whether a temperature of the cover is equal to or lower than a threshold and a stop unit to control the heater to stop heating the cover when the determination unit determines that the temperature of the cover is higher than the threshold are included.

When the determination unit determines that the temperature of the cover is equal to or lower than the threshold, the control unit controls the heater to heat the cover.

Therefore, it is possible to prevent the heater and the cleaner from being operated when snow is not required to be removed.

According to a fifth aspect, the determination unit determines whether a temperature of the cover is equal to or lower than the threshold based on the detected temperature of a heater temperature detector that detects a temperature of the heater.

Accordingly, it is possible for the determination unit to properly determine whether a temperature of the cover is equal to or lower than the threshold based on the detected temperature of the heater temperature detector that detects a temperature of the heater.

According to a sixth aspect, the determination unit determines whether a temperature of the cover is equal to or lower than the threshold based on a detected temperature of an outside air temperature detector that detects a temperature of an outside of the moving body.

Accordingly, it is possible for the determination unit to properly determine whether a temperature of the cover is equal to or lower than the threshold based on the detected temperature of the outside air temperature detector.

1. A snow removing device applied to a moving body that has a light including a cover and a cleaner ejecting a washer solution toward an outer surface of the cover, the cover being exposed to an outside of the moving body, covering a light source, and allowing light emitted from the light source to pass therethrough, the snow removing device comprising:
a heater that heats the cover; and
a control unit that controls the heater to heat the cover first, and then controls the cleaner to eject a washer solution toward the outer surface of the cover.

2. The snow removing device according to claim 1, wherein
the heater is configured to allow the light from the light source to pass through the heater.

3. The snow removing device according to claim 2, wherein
the heater is formed of carbon nanotubes.

4. The snow removing device according to claim 1, further comprising:
a determination unit that is configured to determine whether a temperature of the cover is equal to or lower than a threshold; and
a stop unit that is configured to control the heater to stop heating the cover when the determination unit determines that the temperature of the cover is higher than the threshold, wherein
the control unit is configured to control the heater to heat the cover when the determination unit determines that the temperature of the cover is equal to or lower than the threshold.

5. The snow removing device according to claim 4, wherein
the determination unit is further configured to determine whether a temperature of the cover is equal to or lower than the threshold based on a detected temperature of a heater temperature detector that detects a temperature of the heater.

6. The snow removing device according to claim 4, wherein
the determination unit is further configured to determine whether a temperature of the cover is equal to or lower than the threshold based on a detected temperature of an outside air temperature detector that detects a temperature of an outside of the moving body.

7. A snow removing device applied to a moving body that has a light including a cover and a cleaner ejecting a washer solution toward an outer surface of the cover, the cover being exposed to an outside of the moving body, covering a light source, and allowing light emitted from the light source to pass therethrough, the snow removing device comprising:
a heater that heats the cover; and
an electronic control unit (ECU) that is configured to control the heater to heat the cover first, and then control the cleaner to eject a washer solution toward the outer surface of the cover.

8. The snow removing device according to claim 7, wherein
the heater is configured to allow the light from the light source to pass through the heater.

9. The snow removing device according to claim 8, wherein
the heater is formed of carbon nanotubes.

10. The snow removing device according to claim 7, wherein
the ECU is further configured to:
determine whether a temperature of the cover is equal to or lower than a threshold;
control the heater to stop heating the cover upon determining that the temperature of the cover is higher than the threshold; and
control the heater to heat the cover upon determining that the temperature of the cover is equal to or lower than the threshold.

11. The snow removing device according to claim 10, wherein
the ECU is further configured to determine whether a temperature of the cover is equal to or lower than the threshold based on a detected temperature of a heater temperature detector that detects a temperature of the heater.

12. The snow removing device according to claim 10, wherein
the ECU is further configured to determine whether a temperature of the cover is equal to or lower than the threshold based on a detected temperature of an outside air temperature detector that detects a temperature of an outside of the moving body.
